(19) United States
(12) Patent Application Publication
(10) Pub. No.: US 2004/0013297 A1
(43) Pub. Date: Jan. 22, 2004

(54) Method for performing color gamut compression

(76) Inventor: Roger Lo, Taipei (TW)

Correspondence Address: BIRCH STEWART KOLASCH & BIRCH, PO BOX 747, FALLS CHURCH, VA, 22040-0747, US

(21) Appl. No.: 10/197,490

(22) Filed: Jul. 18, 2002

(51) Int. Cl. G06K 9/00

(52) U.S. Cl. 382/166

(57) ABSTRACT

A method for performing color gamut compression. The method comprises the steps of: (a)receiving pixels indexed to colors of a first palette, (b)receiving a threshold value, (c)assigning one of the colors of the first palette to a second palette and mapping the assigned color thereto, (d)calculating a difference between the colors of the first palette and the second palette, (e)when the differences are larger than the threshold value, assigning the color of the first palette to the second palette and mapping the assigned color thereto, otherwise, mapping the color of the first palette to the nearest color of the second palette, (f)repeating the steps (d) and (e) for all the colors of the first palette, and (g)re-indexing the pixels according to the mapping between the first and second palette.

### BACKGROUND OF THE INVENTION

1. Field of the Invention

The present invention relates to a color gamut compression, particularly to a method for performing color gamut compression which efficiently decreases the size of an image file.

2. Description of the Prior Art

Digital images are composed of pixels. The pixels carry different color information and are visually integrated into a color picture. In a full color image, the colors of the pixels are only limited by the number of digits representing the colors. For limited color gamut images, such as GIF images, the colors of the pixels are intentionally limited to a fixed number. These images are similar to paintings drawn by people using a palette with a limited number of colors. Therefore, each of these image files comprises data for a palette addition to the pixels. The color information carried by the pixels are indexes referring to the colors of the palette.

In some situations, people would like to lower the visual quality of an image file for a small file size. This can be done by color gamut compression- reducing the number of the colors in the palette.

In conventional color gamut compression, a limited color gamut image must be first converted into a full color image. Then, a new palette with a predetermined number of colors is generated by analyzing the color information in the full color image. Finally, by re-indexing the pixels to the colors of the new palette, a limited color gamut image with color space smaller than the source image is obtained.

However, a large memory space is needed to temporally store the full color image, and the analyzing of the color information in the full color image is complicated and time-consuming. The analyzing time depends on the dimension of image. The bigger size the image owns, the more time the analysis needs. Additionally, when more than one source image frames in one image file use a same palette, different new palettes are generated after the conventional color gamut compression. This results in the compressed image file using multiple different palettes, which is disadvantageous to file compression.

### SUMMARY OF THE INVENTION

Therefore, the object of the present invention is to provide a method for performing color gamut compression without conversion and analysis of the full color image.

The present invention provides a method for performing color gamut compression. The method comprises the steps of (a)receiving pixels indexed to colors of a first palette, (b)receiving a threshold value, (c)selecting one of the colors of the first palette as a color of a second palette and mapping the selected color thereto, (d)calculating a color difference between another color of the first palette and each color of the second palette, (e)when all the color differences are larger than the threshold value, assigning the other color of the first palette as another color of the second palette and mapping the other color of the first palette thereto, otherwise, mapping the other color of the first palette to the color of the second palette with the smallest color difference and index number, (f)repeating the steps (d) and (e) for all the colors of the first palette, and (g)re-indexing the pixels to the colors of the second palette according to the mapping between the colors of the first and second palette.

The present invention provides another method for performing color gamut compression. The method comprises the steps of (a)receiving an image and a first palette, wherein the image has pixels carrying first indexes referring to colors of the first palette, (b)receiving a threshold value, (c)initiating a second palette and a mapping table having rows to which the colors of the first palette is mapped, (d)selecting one of the colors of the first palette to be added into the second palette, generating one of second indexes referring to the color added into the second palette, and storing the newly generated second index in the row to which the selected color is mapped, (e)calculating color differences between another color of the first palette and the colors of the second palette, (f)when all the color differences are larger than the threshold value, adding the other color of the first palette into the second palette, generating another of the second indexes referring to the color added into the second palette, and storing the newly generated second index in the row to which the other color is mapped, otherwise, storing in the row to which the other color is mapped the second index of the color of the second palette having the smallest color difference and index number with the other color of the first palette, (g)repeating the steps (e) and (f) for all the colors of the first palette, and (h)changing the first index carried by each of the pixels of the image to the second index stored in the row to which the color referred from the first index is mapped.

The present invention further provides a method for performing color gamut compression. The method comprises the steps of receiving pixels indexed to a first and second color of a first palette, receiving a threshold value, selecting the first color of the first palette as a color of a second palette and mapping the first color thereto, calculating a color difference between the second color of the first palette and the color of the second palette, when the color differences are larger than the threshold value, assigning the second color of the first palette as another color of the second palette and mapping the second color of the first palette thereto, otherwise, mapping the second color of the first palette to the color of the second palette with the smallest color difference and index number, and re-indexing the pixels to the color(s) of the second palette according to the mapping between the colors of the first and second palette.

Thus, in the invention, the palette, instead of the full color image, of the source image is analyzed. The analyzing of the colors of the palette is much easier than that of the full color image and there is no need for a large memory space to temporally store the full color image. This results a more efficient color gamut compression.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a flow chart of a method for performing color gamut compression according to one embodiment of the invention.

FIG. 2A shows a source image having pixels carrying original indexes.

FIG. 2B˜2I show the procedure of the completion of the new palette and mapping table.

FIG. 2J shows a compressed image having pixels carrying new indexes.

### DETAILED DESCRIPTION OF THE INVENTION

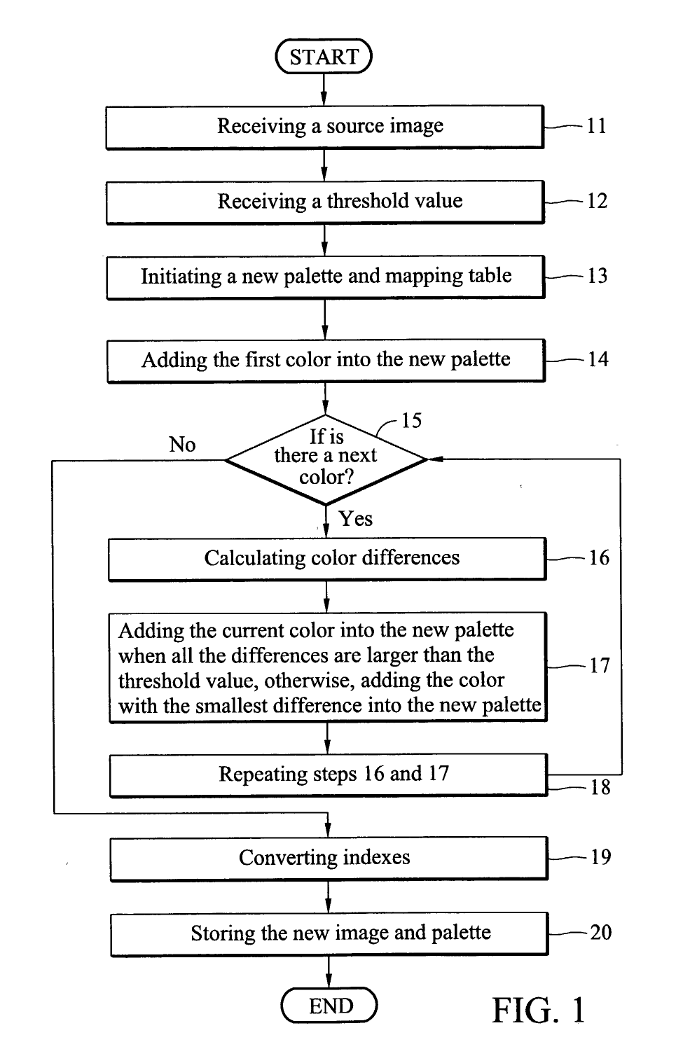

FIG. 1 is a flow chart of a method for performing color gamut compression according to one embodiment of the invention.

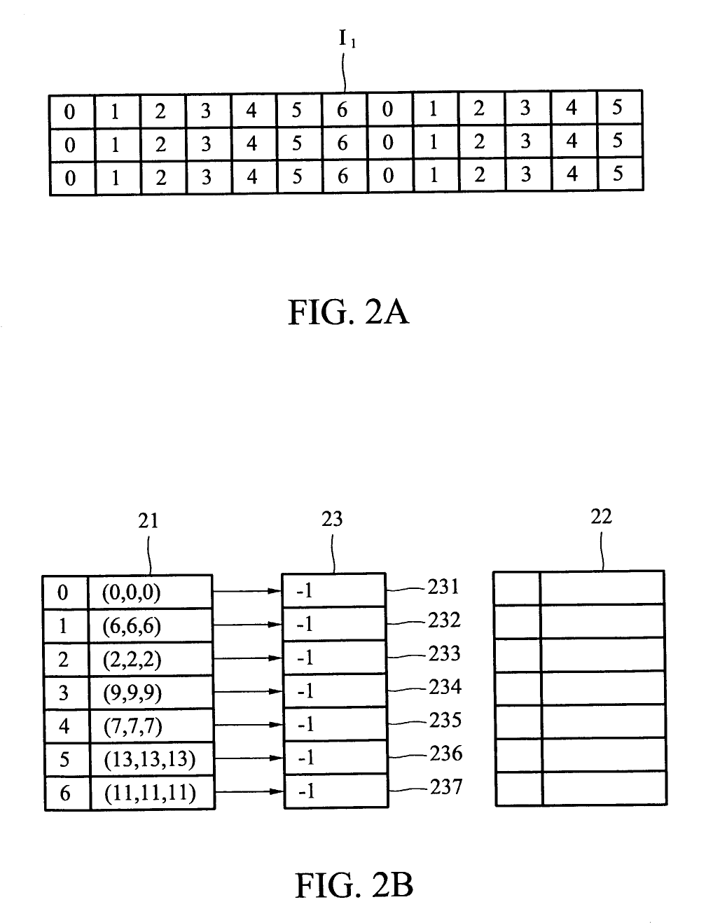

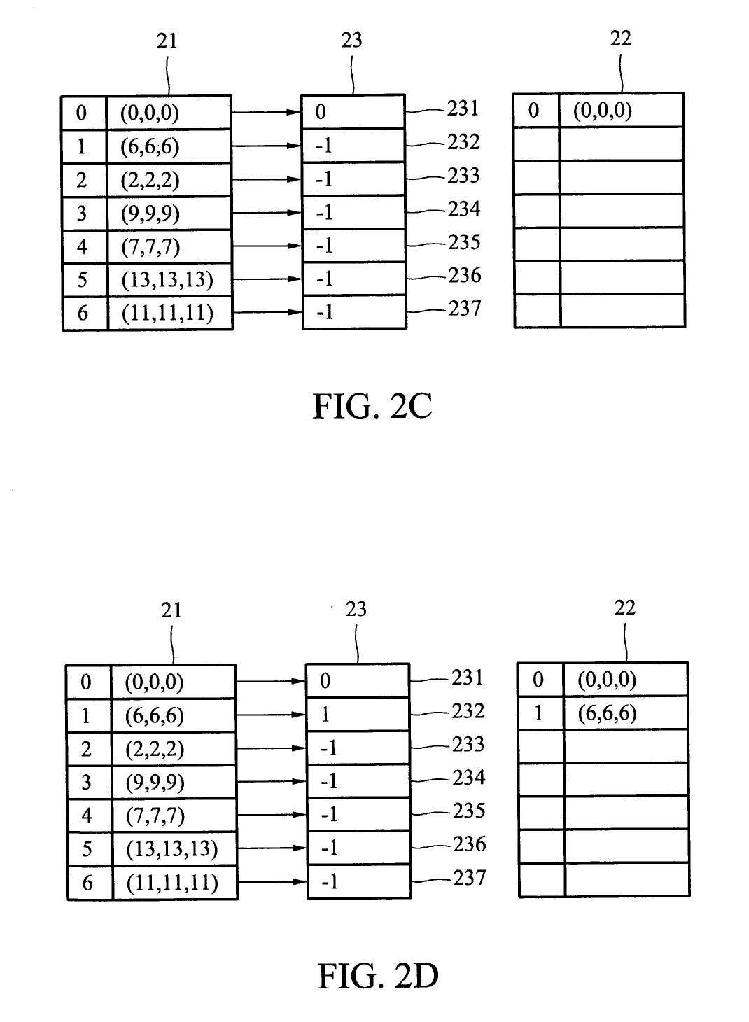

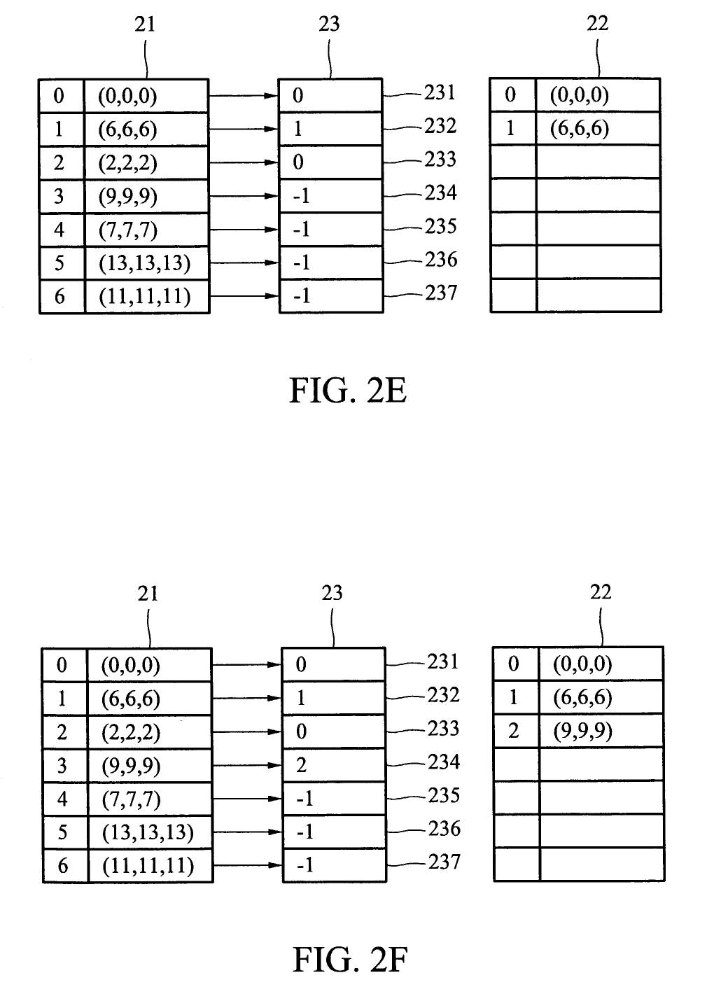

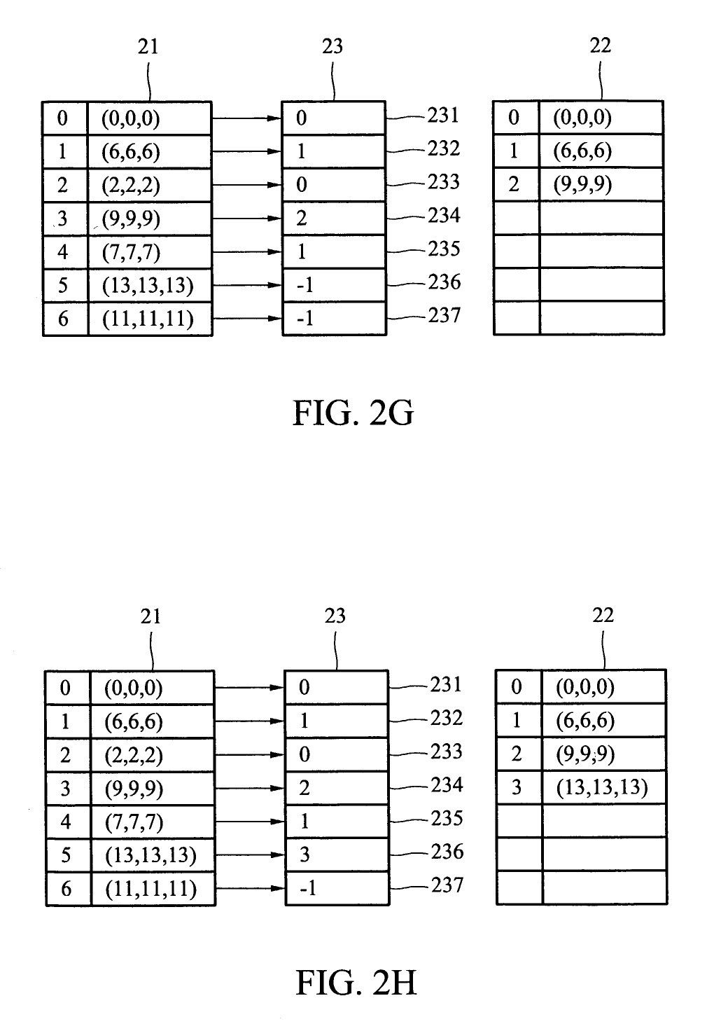

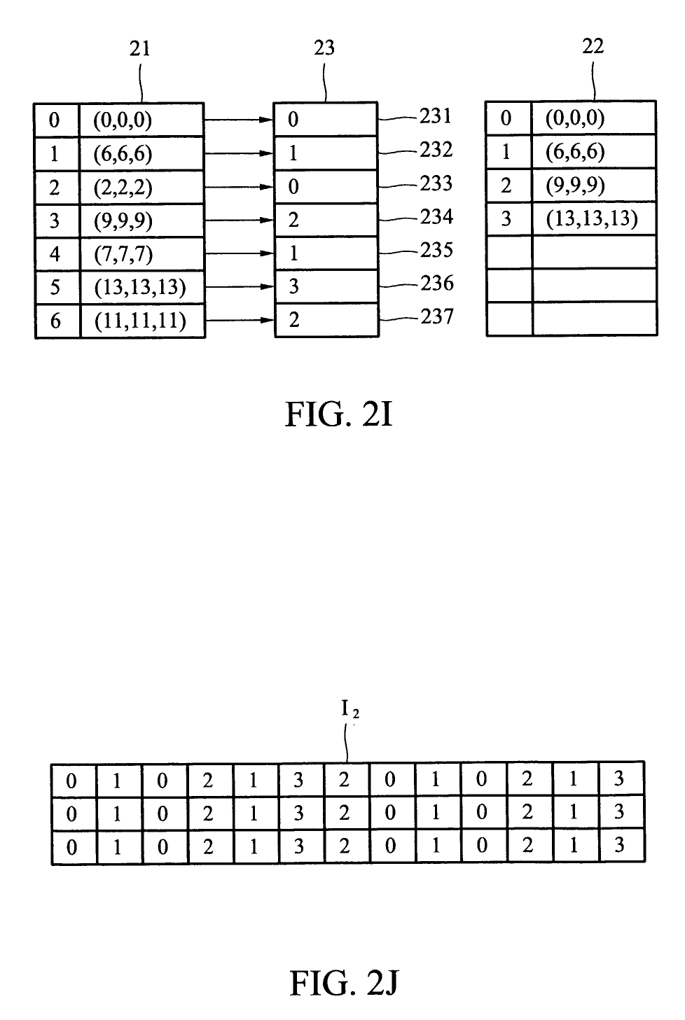

In step 11, a source image I1 shown in FIG. 2A and a corresponding palette are received. The source image has pixels carrying indexes 0, 1, 2, 3, 4, 5 and 6 respectively referring to colors of the palette represented by (0, 0, 0), (6, 6, 6), (2, 2, 2), (9, 9, 9), (7, 7, 7), (13, 13, 13) and (11, 11, 11). It is noted that the indexes are ordered in a sequence and the first, second and third values representing the colors are red, blue and green values respectively.

In step 12, a threshold value 15 is received.

In step 13, a new blank palette 22 and a mapping table 23 are initiated. The mapping table 23 has rows 231˜237 to which the colors of the original palette 21 are mapped, as shown in FIG. 2B. All the values in the rows 231˜237 of the mapping table 23 are initialized to −1.

In step 14, the color (0, 0, 0) of the original palette 21 referred from the first ordered index 0 is added into the new palette 22, a new index 0 referring to the color (0, 0, 0) added into the new palette 22 is generated, and the newly generated index 0 of the color (0, 0, 0) is stored in the row 231 to which the color (0, 0, 0) is mapped, as shown in FIG. 2C.

In step 15, the step 19 is implemented if there is no color of the original palette 21 referred from the next index. Otherwise, the current index is the next index and the step 16 is implemented.

In step 16, color differences between the color referred from the current index of the original palette 21 and the colors added into the new palette 22 are calculated. Each of the color differences of any two of the colors are calculated by summing squares of differences between the values of red, blue and green, as shown in the following equation:

DC=(OCr−NCr)²+(OCb−NCb)²+(OCg−NCg)²,

wherein DC is the color difference, OCr, Ocb and Ocg are the red, blue and green values of the color of the original palette, and NCr, Ncb and Ncg are the red, blue and green values of the color of the new palette.

In step 17, when all the color differences DC calculated in the step 16 are larger than the threshold value, the color of the original palette 21 referred from the current index is added into the new palette 22, another new index referring to the color added into the new palette is generated, and the newly generated index is stored in the row to which the color referred from the current index is mapped. Otherwise, the index of the color of the new palette having the smallest color difference and index number with the color referred from the current index is stored in the row to which the color referred from the current index is mapped.

In step 18, the steps 16 and 17 are repeated for all the colors of the original palette 21 in the sequence of their indexes.

FIGS. 2D˜2I show the procedure of the completion of the new palette 22 and mapping table 23 by the steps 15˜18.

As shown in FIG. 2D, the current index is 1, the color (6, 6, 6) of the original palette 21 referred from the index 1 is added into the new palette 22, a new index 1 referring to the color (6, 6, 6) added into the new palette 22 is generated, and the newly generated index 1 is stored in the row 232 to which the color (6, 6, 6) referred from the current index 1 is mapped since the color difference DC between the color (6, 6, 6) referred from the current index 1 of the original palette 21 and the color (0, 0, 0) of the new palette 22 is larger than 15.

As shown in FIG. 2E, the current index is 2, the index 0 of the color (0, 0, 0) of the new palette 22 having the smallest color difference DC with the color (2, 2, 2) referred from the current index 2 is stored in the row 233 to which the color (2, 2, 2) referred from the current index 2 is mapped since not all the color differences DC calculated in the step 16 are larger than the threshold value 15.

As shown in FIG. 2F, when the current index is 3, the color (9, 9, 9) of the original palette 21 referred from the index 3 is added into the new palette 22, a new index 2 referring to the color (9, 9, 9) added into the new palette 22 is generated, and the newly generated index 2 is stored in the row 234 to which the color (9, 9, 9) referred from the current index 3 is mapped since the color differences DC between the color (9, 9, 9) referred from the current index 3 of the original palette 21 and the colors (0, 0, 0) and (6, 6, 6) of the new palette 22 are both larger than 15.

As shown in FIG. 2G, when the current index is 4, the index 1 of the color (6, 6, 6) of the new palette 22 having the smallest color difference DC with the color (7, 7, 7) referred from the current index 4 is stored in the row 235 to which the color (7, 7, 7) referred from the current index 4 is mapped since not all the color differences DC calculated in the step 16 are larger than the threshold value 15.

As shown in FIG. 2H, when the current index is 5, the color (13, 13, 13) of the original palette 21 referred from the index 5 is added into the new palette 22, a new index 3 referring to the color (13, 13, 13) added into the new palette 22 is generated, and the newly generated index 3 is stored in the row 236 to which the color (13, 13, 13) referred from the current index 5 is mapped since all the color differences DC between the color (13, 13, 13) referred from the current index 5 of the original palette 21 and the colors (0, 0, 0), (6, 6, 6) and (9, 9, 9) of the new palette 22 are larger than 15.

As shown in FIG. 2I, when the current index is 6, the index 2 of the color (9, 9, 9) of the new palette 22 having the smallest color difference DC with the color (11, 11, 11) referred from the current index 6 is stored in the row 237 to which the color (11, 11, 11) referred from the current index 6 is mapped since not all the color differences DC calculated in the step 16 are larger than the threshold value 15. It is noted that the color (13, 13, 13) also has the smallest color difference with the color (11, 11, 11). However, the index 2 of the color (9, 9, 9) of the new palette 22 is selected to be stored since it is smaller than the index 3 of the color (13, 13, 13) of the new palette 22.

In step 19, the original index carried by each of the pixels of the source image I1 is changed to the new index stored in the row of the mapping table to which the color referred from the original index is mapped. This results a compressed image I2 as shown in FIG. 2J.

In step 20, the new palette and the compressed image having the pixels carrying the new indexes are stored. The colors of the new palette are less than the colors of the original palette. The difference between the number of the colors of the original and new palette is determined by the threshold value.

In conclusion, the present invention provides a method for performing color gamut compression without conversion and analysis of the full color image. The palette, instead of the full color image, of the source image is analyzed. The analyzing of the colors of the palette is much easier than that of the full color image and there is no need for a large memory space to temporally store the full color image. This results in a more efficient color gamut compression.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for performing color gamut compression comprising the steps of:
(a)receiving pixels indexed to colors of a first palette;
(b)receiving a threshold value;
(c)selecting one of the colors of the first palette as a color of a second palette and mapping the selected color thereto;
(d)calculating a color difference between another color of the first palette and each color of the second palette;
(e)when all the color differences are larger than the threshold value, assigning the another color of the first palette as another color of the second palette and mapping the another color of the first palette thereto, otherwise, mapping the another color of the first palette to the color of the second palette with the smallest color difference;
(f)repeating the steps (d) and (e) for all the colors of the first palette; and
(g)re-indexing the pixels to the colors of the second palette according to the mapping between the colors of the first and second palette.

2. The method as claimed in claim 1 wherein all the colors are represented by values of red, blue and green, and each of the color differences of any two of the colors are calculated by summing squares of differences between the values of red, blue and green.

3. The method as claimed in claim 1, wherein the number of the colors of the second palette varies with the threshold value.

4. The method as claimed in claim 1 further comprising the step of:
storing the second palette and the re-indexed pixels.

5. A method for performing color gamut compression comprising the steps of:
(a)receiving an image and a first palette, wherein the image has pixels carrying first indexes referring to colors of the first palette;
(b)receiving a threshold value;
(c)initiating a second palette and a mapping table having rows to which the colors of the first palette is mapped;
(d)selecting one of the colors of the first palette to be added into the second palette, generating one of second indexes referring to the color added into the second palette, and storing the newly generated second index in the row to which the selected color is mapped;
(e)calculating color differences between another color of the first palette and the colors of the second palette;
(f)when all the color differences are larger than the threshold value, adding the another color of the first palette into the second palette, generating another of the second indexes referring to the color added into the second palette, and storing the newly generated second index in the row to which the another color is mapped, otherwise, storing in the row to which the another color is mapped the second index of the color of the second palette having the smallest color difference with the another color of the first palette;
(g)repeating the steps (e) and (f) for all the colors of the first palette; and
(h)changing the first index carried by each of the pixels of the image to the second index stored in the row to which the color referred from the first index is mapped.

6. The method as claimed in claim 5 wherein all the colors are represented by values of red, blue and green, and each of the color differences of any two of the colors are calculated by summing squares of differences between the values of red, blue and green.

7. The method as claimed in claim 5, wherein the colors of the second palette are less than the colors of the first palette.

8. The method as claimed in claim 5 further comprising the step of:
storing the second palette and the image having the pixels carrying the second indexes.

9. The method as claimed in claim 5, wherein the first indexes are ordered in a sequence, the color selected in the step (d) is referred from the first ordered first index, and the steps (e) and (f) are repeated for each of the colors in the sequence of the first index referring thereto.

10. A method for performing color gamut compression comprising the steps of:
receiving pixels indexed to a first and second color of a first palette;
receiving a threshold value;
selecting the first color of the first palette as a color of a second palette and mapping the first color thereto;
calculating a color difference between the second color of the first palette and the color of the second palette;
when the color differences are larger than the threshold value, assigning the second color of the first palette as another color of the second palette and mapping the second color of the first palette thereto, otherwise, mapping the second color of the first palette to the color of the second palette with the smallest color difference; and
re-indexing the pixels to the color(s) of the second palette according to the mapping between the colors of the first and second palette.

11. The method as claimed in claim 10 wherein all the colors are represented by values of red, blue and green, and the color difference of the second color of the first palette and the color of the second palette are calculated by summing squares of differences between the values of red, blue and green.

12. The method as claimed in claim 10 further comprising the step of:
storing the second palette and the re-indexed pixels.
